(19) United States
(12) Patent Application Publication
(10) Pub. No.: US 2009/0094081 A1
(43) Pub. Date: Apr. 9, 2009

(54) APPARATUS, METHOD, AND SYSTEM TO MONITOR PERFORMANCE OF COIN ACCEPTORS, BILL VALIDATORS, AND OTHER AUTOMATED PAYMENT METHODS

(75) Inventors: FRANCIS A. WITTERN, III, WEST DES MOINES, IA (US); JEFFREY W. MAYOROS, CLIVE, IA (US)

Correspondence Address: MCKEE, VOORHEES & SEASE, P.L.C., 801 GRAND AVENUE, SUITE 3200, DES MOINES, IA, 50309-2721, US

(73) Assignee: FAWN ENGINEERING CORP., DES MOINES, IA (US)

(21) Appl. No.: 12/248,694

(22) Filed: Oct. 9, 2008

Related U.S. Application Data
(60) Provisional application No. 60/978,485, filed on Oct. 9, 2007.

(51) Int. Cl. G06Q 10/00

(52) U.S. Cl. 705/7

(57) ABSTRACT

An apparatus, system, and method of monitoring performance of a currency detector such as a coin acceptor or bill validator. Status of the currency detector relative to each item introduced to it is tracked. A ratio of rejected items to accepted items is compiled over a given period of time to create a rejection rate. Rejection rate can be displayed or communicated to another device. The rejection rate can be used to indicate poor operation or malfunction of the currency detector. It may indicate attempts at cheating. It also can be used to attempt to improve performance or adjust or train operation of the currency detector. Analogous techniques can be used to monitor performance of a credit card or proximity card reader.

### CROSS-REFERENCE TO RELATED APPLICATIONS

This application claims priority under 35 U.S.C. § 119 of a provisional application Ser. No. 60/978,485 filed Oct. 9, 2007, which application is hereby incorporated by reference in its entirety.

### BACKGROUND OF THE INVENTION

A. Field of the Invention

The present invention relates to automated payment acceptors, such as coin acceptors/changers, bill validators, credit card readers, proximity card readers, and the like, and in particular, apparatus and methods for monitoring, analyzing, and using coin, bill, or other payment transaction acceptance and/or rejection information related to a coin or bill acceptor validator or other automated payment components.

B. Problems in the Art

Coin acceptors and bill validators are used in a variety of applications. Frequently these devices are used in vending machines that accept payment and dispense product to a customer. They can also be used in change machines, slot machines, or in other machines or devices that require pre-payment or credit before performing some function.

Coin and bill acceptors or validators are sometimes collectively called currency detectors. The “currency” can be legal tender such as monetary coins or paper currency. It can also include tokens, coupons, paper pieces or coin- or bill-shaped pieces having one or more physical characteristic(s) that is/are recognizable by the currency detector.

If the “currency” is accepted, it is retained by the machine and placed in a storage location. If it is rejected, most times the machine returns the item. If a coin, it usually drops into a container for the customer to take back. If a bill, the machine normally pushes it back out for removal by the customer.

As mentioned, currency detectors, particularly bill validators, are used in applications other than vending machines. Other examples are money changing units, subway or train pass vendors, and automated cash handling systems for banking, retail, casino and other industries. Further examples are video or arcade games, photocopiers, computers, and internet terminals, to name just a few. The primary benefit is automatized delivery of selected product or functions to a customer after confirmation, validation, and/or crediting (sometimes called “acceptance”) of the “currency”.

The development of currency detectors (both coin acceptors/changers and bill validators) has focused on accurate recognition of valid, non-counterfeit currency. This is not a trivial endeavor. The currency detector must automatically decide if it senses a valid coin, as well as the denomination (e.g. in the United States a nickel, dime, quarter, half dollar, or dollar coin); or if it is valid paper currency (e.g. in the U.S. a dollar bill, a five dollar bill, a ten dollar bill, etc.), based on one or more measurable characteristic of the currency (e.g. size, shape, weight, magnetism, etc.). Accuracy has improved in recent years. Acceptance rates can typically exceed 90%.

Accuracy, even at such seemingly high percentages, remains an issue with respect to currency detector performance. Any non-acceptance of legitimate currency can frustrate and alienate customers. A five percent or more error rate raises the specter of cheating. If the detector is not completely reliable in its recognition of acceptable currency, counterfeit currency may be erroneously accepted and credited.

Additionally, the purchaser of the currency detector (e.g. the owner/operator of a vending machine or other machine that functions after validation of sufficient payment) has no practical way to verify the payment acceptance rate of the currency detector. Many times the owner/operator simply relies on the published or claimed accuracy by the manufacturer. Thus, the actual accuracy can be materially different than the claimed accuracy.

Such reliance can be risky for the owner/operator. Some examples with respect to vending machines are illustrative. First, a currency detector with a high rejection rate can lead to disgruntled or dissatisfied customers. This can translate into lost sales. The owner/operator may be essentially “walking away” from sales by leaving such a currency detector in place. These lost sales can be multiplied if a vending machine is in a location where vending customers likely would repeat their business. But there is no way for the owner/operator to practically monitor the performance of the currency detector. There is no way to confirm if the manufacturer's claimed or published acceptance rate is accurate. Second, some currency detectors shut off the currency detector if coins or bills jam. But there is no way to monitor if a currency detector is exhibiting symptoms of possible future or imminent failure or malfunction. For example, over time such detectors get dirty. Their performance tends to degrade.

These problems are exacerbated by the increasing demands on currency detectors. For example, not only plural coins but plural bills must be handled. Newer detectors typically can be programmed to accept and give credit for a variety of currency types and denominations, including currency from different countries. Also, more sophisticated auditing is in demand. For example, operators of vending machines find it desirable to be able to compare the actual physical amount of currency collected at the currency detector to data stored by the detector regarding accepted currency.

However, the focus by manufacturers of currency detectors on improved accuracy and enhanced features such as handling more and different types of coin and paper bills has not addressed the types of problems discussed earlier. This leaves room for improvement in the art.

Furthermore, there are a variety of possible reasons why currency is not accepted or credited. One is because it is counterfeit. But others include such things as (a) it is not recognized by the currency detector; (b) improper transport or routing of otherwise valid currency (jamming, misalignment, falling out of the routing path, etc.), and (c) it is valid and recognized as valid but somehow not credited to the customer.

Currency detector manufacturers may build them to detect one or more reasons for non-acceptance or no crediting, but are not known to attempt to monitor or aggregate the cumulative effect of the various non-acceptance or non-crediting of currency. They do not have any incentive to monitor and analyze the different possible causes for non-acceptance or non-crediting of coins and bills, as they wish to accentuate the accuracy of their products. Thus, there is room for and a need for improvement in reducing inaccurate handling of currency or providing the ability to analyze the handling of currency.

Additionally, many payment methods in the future will involve credit cards or what are called “smart cards” or “proximity cards”. Instead of currency, the customer inserts, swipes, or even merely places the card or device in proximity to a corresponding reader, and validation and credit is given. However, analogous issues exist with regard to these devices. There are several reasons why a valid card is not credited, including but not limited to lack of accuracy or improper performance by the reader, or processing issues. Therefore, similar problems and issues exist for these payment methods as with coin and bill acceptors and validators.

### BRIEF SUMMARY OF THE INVENTION

It is therefore a principal object, feature, advantage or aspect of the present invention to provide an apparatus, method, and system which analyzes rejection of currency from a currency detector and stores or uses the results of such analysis. It is a further object, feature, advantage, or aspect of the present invention to provide an apparatus, system, and method as above-described which:
a. provides additional or increased currency rejection or no-crediting information;
b. provides additional or increased anti-cheat capability;
c. allows collection and accumulation of rejection or no-credit information from a variety of causes;
d. allows comparison of accumulated rejection information with acceptance information;
e. can assist in identifying and notifying of a potential malfunction of the currency detector; and/or
f. can be used to improve the accuracy and effectiveness of handling of currency.

In one aspect of the invention, a method according to the invention comprises monitoring operation of a currency detector to derive information that can be correlated to a rejection quantity or value and an acceptance quantity or value for the currency detector. The rejection and acceptance quantities or values can be stored. The quantities or values can be used for a variety of purposes. One is to characterize the currency detector in terms of an acceptance-to-rejection ratio. Another would be to recognize a malfunction or sub-optimal functioning of the currency detector.

In one aspect of the method, each attempt to place an item into the currency detector is monitored. Acceptance or rejection of the item is communicated to a controller or storage medium. Information can be collected based on a variety of factors including, but not limited to, a factor such as a selected period of time.

In another aspect of the invention, an apparatus comprises a currency detector. The currency detector includes a processor which stores digital information regarding state or status of the currency detector related to whether an item is indicated to be acceptable or not. A controller is in communication with the currency detector processor and periodically queries or polls the currency detector regarding state or status. The controller keeps track of acceptance or rejection of each item and stores that information. An acceptance to rejection ratio can be calculated by the controller and is then available for an analysis or use. The methods and apparatus described above apply in analogous ways to other payment methods, including but not limited to credit card readers and proximity card readers.

In one aspect, the controller described above is a vending machine controller for a vending machine. The acceptance-to-rejection ratio can be displayed on a display device. It can also be communicated to a remote site by, for example, land line or wireless communication. Furthermore, it can activate a human-perceivable signal or alarm if the acceptance-to-rejection ratio (or other data from the monitoring) is indicative of present or possible future malfunction of the currency detector, or of an unacceptable ratio of acceptance to rejection. In other aspects of the invention, the controller can be associated with another type of machine that depends on an automated payment or credit validator or reader to provide products or services to a customer. The controller can be external of the currency detector or even the machine associated with the currency detector.

These and other objects, features, advantages, or aspects of the present invention will become more apparent with reference to the accompanying specification and claims.

### BRIEF DESCRIPTION OF THE DRAWINGS

FIG. 1 is a block diagram of a typical vending machine.

FIG. 2 is a more detailed block and pictorial diagram of the components of FIG. 1 which typically handle currency, such as a coin accumulator and a bill validator.

FIG. 3 is a flow diagram of a method of collecting and analyzing rejection information for the coin accumulator and bill validator of FIG. 2.

FIG. 4 is a table of exemplary information that can be used in analyzing rejection and acceptance rates for a coin accumulator.

FIG. 5 is a table of exemplary information that can be used in analyzing acceptance and rejection rates for a bill validator.

FIG. 6 is a screen display of a diagnostic test regimen for calling up and displaying coin and bill rejection rates.

### DETAILED DESCRIPTION OF EXEMPLARY EMBODIMENTS

A. Overview

For a better understanding of the invention, one example of a form the invention can take is now described in detail. Reference will be frequently made to the accompanying drawings. Reference numbers will be used to indicate certain parts and locations in the drawings. The same reference numbers will be used to indicate the same or similar parts and locations throughout the drawings unless otherwise indicated.

This exemplary embodiment is intended to illustrate just one form the invention can take. It is not inclusive or exclusive. Variations obvious to those skilled in the art will be included within the invention, which is defined solely by the claims following this description.

This exemplary embodiment will be described in the context of an automated merchandising or vending machine. Typically such a vending machine provides snacks, beverages, or other products to consumers without a cashier. The exemplary embodiment will be described in the context of a vending machine which includes a vending machine controller (VMC), such as are well known in the art. The VMC includes a programmable processor with memory that can communicate via a multi-drop bus (MDB) type interface between the VMC and a variety of components.

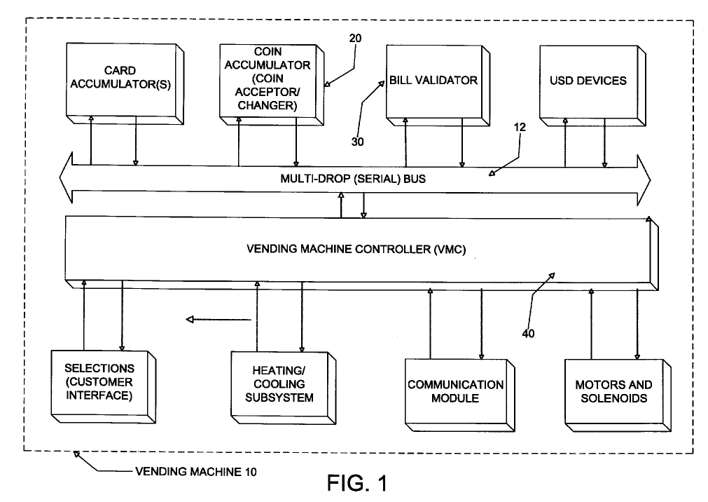

A typical vending machine 10 is diagrammatically illustrated in FIG. 1. VMC 40 communicates via MDB 12 to coin accumulator 20 and bill validator 30. This allows consumers to use either paper currency or coins. Debit or credit cards can also be used via a cardreader. As indicated in FIG. 1, the VMC typically operates dispensers by programmed actuation of motors and solenoids in response to consumer-operated selections via a selection interface (e.g. keyboard or buttons). Heating and cooling components can be operated by the VMC, if needed.

Such vending machines are well known and available from a wide variety of manufacturers. Examples are GF-12 Snack, HR-32 Super Vendor, and CD-6 Machines, operating with an MDB interface from U-Select-It of Des Moines, Iowa USA. It is to be understood, however, that just a coin accumulator or a bill validator, but not both, can be used with vending machine 10. It is also to be understood that instead of a vending or automated merchandising machine 10, either or both of coin accumulator 20 and bill validator 30 could be utilized with some other machine. Examples have been previously mentioned and include, but are not limited to, coin or bill changers, arcade games, laundromat machines, or any machine that requires payment or value or authorization through coin, paper currency, coupon, tokens, or the like to provide a function.

B. Apparatus

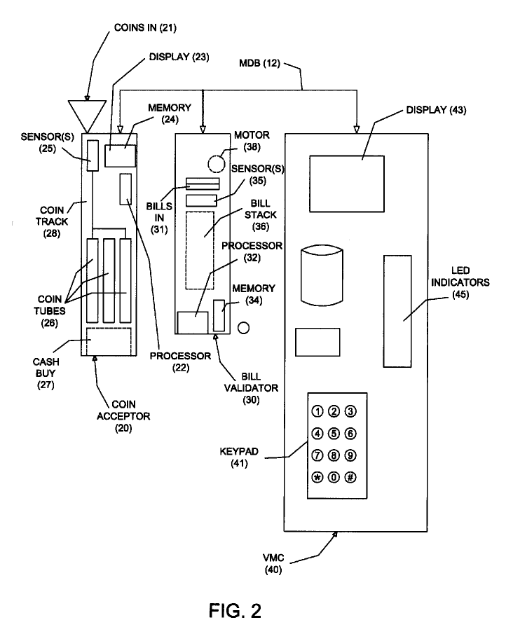

FIG. 2 illustrates in more diagrammatic detail the primary components of an apparatus that can be operated according to the exemplary embodiment. As is typical, coin accumulator or acceptor 20 includes a chute or slot 21 into which coins can be inserted. Internal processor 22 with associated memory 24 is operatively connected to one or more sensors 25 which test one or more physical properties of an inserted item against known composites from coinage that is/are deemed acceptable. Examples of such physical properties are weight, size, and magnetism. The coins move (e.g. by gravity) along a track 28. If sensors 25 accept the item, processor 22 controls actuators or gates which allow the item to move into one of a coin tube 26 or cash box 27 in coin accumulator 20, depending on programmed parameters. An example of a commercially available coin acceptor or accumulator/changer 20 is a Model CP 7000 from MEI of West Chester, Pa. USA.

As is well known, it is typical for coin accumulator 20 to keep track of the state or status of the coin as it is being processed. In particular, it is typical that processor 22 would recognize and assign a status to an item that has been introduced into device 20. For example, according to MDB protocol, coin accumulator 20 can assign a unique status to an item inserted but not yet validated or accepted. A different state or status can be assigned once the item is recognized as a type enabled and accepted by device 20 but before it is validated. Still further, a different state or status can be assigned once a coin is validated but not yet credited. Another state can be assigned once a coin that has been both validated and accepted such that the coin is also credited as monetary value or credit. Another state can be assigned for any item that is rejected by coin acceptor 20. As mentioned previously, there can be one or more reasons a coin is deemed rejected.

Many coin accumulators 20 can be initialized or set up to accept and credit different types and/or denominations of coins and tokens. They can be set to accept and credit all or a subset of conventional coin denominations. For example, many coin acceptors 20 do not accept pennies. They also could be set by appropriate means to only accept quarters or only accept quarters and dimes. This function is well known. This is generally referred to enabling specific acceptable coin denominations and is usually adjustably settable by the operator. As illustrated in FIG. 2, coin acceptor 20 can have a plurality of what are known in the art as coin tubes 26. Different types of coins can be routed through the component 20 to different tubes 26. It also can have a cash box 27 into which any type of coin can be routed. In either case, device 20 would have validated and accepted (credited) the coin. A unique status can be assigned to coins sent to any tube 26 and a unique status to coins sent to cash box 27. Both states would be considered to be accepted (credited) coins.

In a similar fashion, bill validator 30 includes some sort of slot or receiver 31 into which bills or thin pliant sheet items can be inserted. Processor 32, with associated memory 34, controls one or more sensors 35 and motor/transport mechanism 38 to evaluate and route the item inserted in slot 31. A conventional evaluation is to scan pliant currency using optical and magnetic sensors. By calibration and preprogramming, as well as operator initialization, bill validator 30 can be set to accept different types and denominations of valid paper currency, as well as other pliant items such as authorized coupons. A motor and transport mechanism 38 moves or routes the item into bill validator 30 for evaluation by sensors 35. As with coin accumulator 20, bill validator 30 can keep track of different states or status of the bill in validator 30. Common examples would be (a) the item is being evaluated by sensors 35 but is not yet validated, (b) the item has been validated but is not yet credited, and (c) the item has been validated and stored or stacked (credited). The motorized device 38 can move or route a validated and credited bill to a bill stack or storage location 36. An example of a commercially available bill validator 30 is a BillPro™ brand device from Coinco of St. Louis, Mo. USA.

MDB interface 12 allows VMC 40 to communicate in two-way fashion with both coin accumulator 20 and bill validator 30. MDB refers to well-known and widely used Multi-Drop Bus protocol promulgated by the National Automated Merchandising Association (NAMA) as a vending industry standard. A specific version is the Multi-Drop Bus/Internal Communication Protocol (MDB/ICP) 3.0 (available from NAMA). The standard promotes the ability for a variety of different kinds and brands of components to be used with a variety of different brands of vending machines. An analogous standard is the European Vending Association's Data Exchange Interface (DEX).

MDB and DEX also allow for transfer of information from a VMC to peripherals, such as indicated in FIG. 1. They also allow transfer of information to a data collection device. The data is typically stored at or in the VMC. The data can relate to transactions, sales, cash collections, product movement, and other vending machine activities. It can be stored for later collection with a collection device by an operator or personnel who, on a recurrent basis, visits vending machine 10 to download the data and restock inventory. Through a communication interface or module (see FIG. 1) data can also be transmitted to other devices, including off-site or remote computers.

The present exemplary embodiment will be discussed in the context of MDB. As will be appreciated by those skilled in the art, other communication protocols or systems can be used. VMC processor 42 is programmable to query or poll coin accumulator 20 and bill validator 30 for status or state. It can therefore monitor state or status of an item introduced into coin accumulator 20 and/or bill validator 30 and accumulate that information over a period of time.

As noted in FIG. 2, VMC 40 includes an input interface, here a keyboard 41, allowing an operator to program or instruct VMC 40 to accomplish certain functions. A display 43 and LEDs 45 provide visual indication or information to the operator.

VMC 40 also controls the basic operation of vending machine 10, primarily actuating any dispenser, motors or solenoids (FIG. 1) for moving a product to a delivery area in vending machine 10 in response to a selection by a consumer after payment.

C. Operation

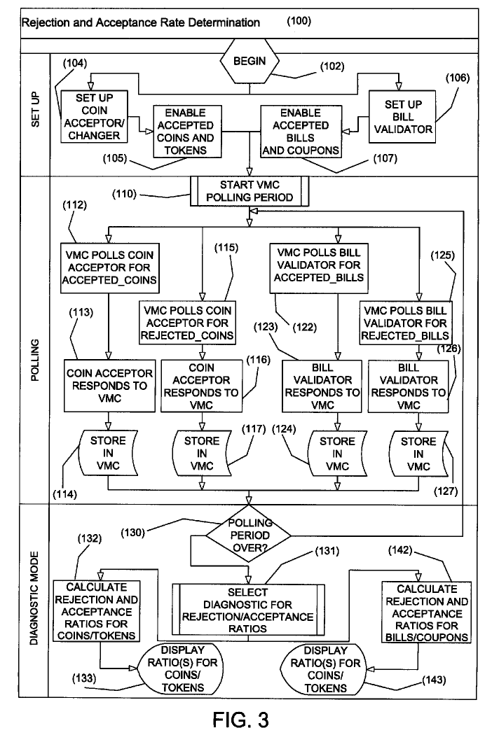

FIG. 3 is a flow chart of a basic method 100 of monitoring coin acceptor 20 and bill validator 30 of vending machine 10 according to the exemplary embodiment.

1. Set Up

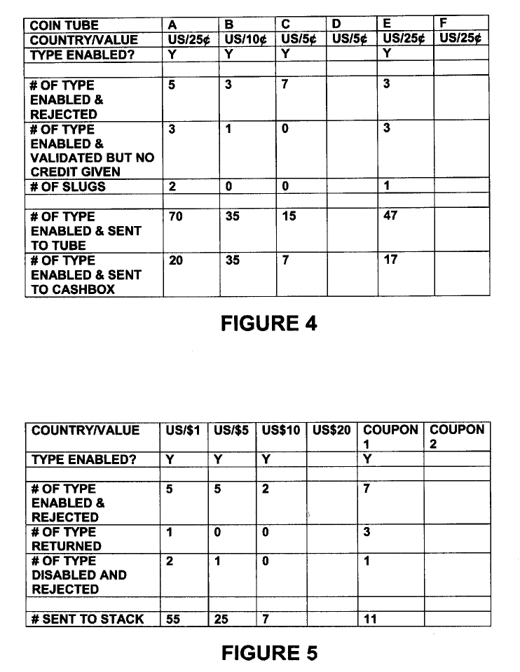

The owner/operator of vending machine 10 initializes coin accumulator 20 and bill validator 30 (FIG. 3A) through a set up procedure (step 104 for coin acceptor 20; step 106 for bill validator 30). One part of set up is to enable which coins, tokens, bill denominations, and coupons are acceptable (step 105 for coin acceptor 20; step 107 for bill validator 30). As indicated in FIG. 4, in this example coin acceptor 20 is set up to enable acceptance of United States nickels, dimes, and quarters. It is also set up to route quarters to coin tubes A and E, dimes to tube B and nickels to tube C. In this example, it can be set up to route any accepted/credited coin to a cash box. Coin acceptor 20 has an input interface (not shown), such as a touch screen or push buttons, which allows an operator to follow a menu-driven set up and coin enablement program. The operator can call up, for example, a coin denomination enable routine and select which coins are enabled; that is, which coins are eligible for receiving credit if validated.

Similarly, bill validator 30 can be selectably initialized to accept different bill types and denominations. As indicated in FIG. 5, in this example, U.S. bills of one, five, and ten dollar amounts are enabled. Twenty dollar bills are disabled.

By also referring to FIGS. 4 and 5, other types of “currency” can be programmably enabled by either device 20 or 30. As is well known, tokens could be enabled for coin accumulator 20. Coupons could be enabled for bill validator 30. Instructions for the enablement process are provided by the manufacturers of devices 20 and 30. U.S. Pat. No. 7,216,754, which is incorporated by reference herein, also describes this process, which is well-known in the art.

2. Polling

Once initialized, coin acceptor 20 and bill validator 30 wait for insertion of currency and VMC 40 begins polling them (step 110). Polling is a well known concept with MDB protocol. Under MDB protocol, VMC 40 automatically issues a periodic command (typically every 25-200 milliseconds (ms)) asking each of coin accumulator 20 (step 112) and bill validator 30 (step 122) for its activity status.

The following table indicates the MDB/ICP activity status bytes that are available to communicate to the VMC:

Status Bytes From Coin Acceptor 20 In Response to VMC “Poll Command”

| MBD/ICP Status Byte | Status Description |
|---|---|
| “Coins Deposited” status and “Coin | A coin of enabled type has been |
| Routing” is indicated to “Tubes” | routed to a coin tube 26 |
| | or |
| | “coin type enabled sent to tubes” |
| “Coins Deposited” status and “Coin | A coin of enabled type has been |
| Routing” is indicated to “cash box” | routed to the cash box 27 |
| | or |
| | “coin types enabled and sent |
| | to cash box” |
| “Coins Deposited” status and “Coin | A coin of enabled type has |
| Routing” is indicated to be“Rejected” | been rejected or |
| | “coin type enabled but coin |
| | rejected” |
| “No Credit” status | A coin of enabled type has not |
| | been given credit |
| | or |
| | “no credit message coins” |
| “Slug” status | An item inserted is considered a |
| | slug (with coins or tokens enabled) |
| | or |
| | “slugs (with coins or tokens |
| | enabled)” |

Further details regarding the VMC polling commands and the format and content of information that can be communicated back to the VMC via MBD protocol can be found at the published MDB/ICP protocol version 3.0, which is incorporated by reference herein in its entirety (available from National Automatic Merchandising Association, 20 N. Wacker Drive, Suite 3500, Chicago, Ill. 60606-3120 USA entitled “Multi-Drop Bus/Internal Communication Protocol MDB/ICP Version 3.0”). See, for example, Section 5 of Version 3.0. Coin acceptor 20 generates a state byte for any of these conditions and holds it until polled by VMC40, at which time coin acceptor 20 responds to the poll (steps 113 and 116) by sending a communication back to VMC 40 that includes the state bytes that have accumulated since the last polling. The information is stored in VMC 40 (step 114 and 117). In this way, so long as VMC 40 is in the polling period 110 (e.g. the time between visits by the owner/operator of vending machine 10), VMC 40 will collect and store, on a cumulative basis, information that has been determined to be indicative of total coins accepted and information that has been determined to be indicative of total items rejected.

In an analogous fashion, bill validator 30 is set up to respond (steps 123 and 126) to polling from VMC 40, and VMC 40 stores (steps 124 and 127) polled bytes.

Activity Status Bytes From Bill Validator 30 In Response to VMC “Poll Command”

The following table lists the MBD/ICP activity status bytes that are available for communication to the VMC 40 and the information they carry:

| MBD/ICP Status Byte | Status Description |
|---|---|
| “Bills Accepted” status and “Bill | A bill of enabled type has been accepted |
| Routing” indicated to be “Bill | or |
| Stacked” | “stacked bills” |
| “Bills Accepted” status and “Bill | An item inserted has been returned |
| Routing” indicated to be “Bill | or |
| Returned” | “bill type returns” |
| “Bills Accepted” status and “Bill | A bill of disabled type has been rejected |
| Routing” indicated to be | or |
| “Disabled Bill Rejected” | “bill type disabled bill rejected” |
| “Bill Rejected” Status | A bill of enabled type has been rejected |
| | or |
| | “bill rejected” |

There are a number of other activity status bytes for coin acceptor 20 and bill validator 30. In this example, all or some of those listed above are used in the next step of calculating rejection and acceptance rates for coin acceptor 20 and bill validator 30. Further details regarding the VMC polling commands and the format and content of information that can be communicated back to the VMC via MBD protocol can be found at the published MDB/ICP protocol version 3.0 incorporated by reference herein. See, e.g., Section 6.

3. Diagnostic Mode-Calculation of Rejection and Acceptance Rates

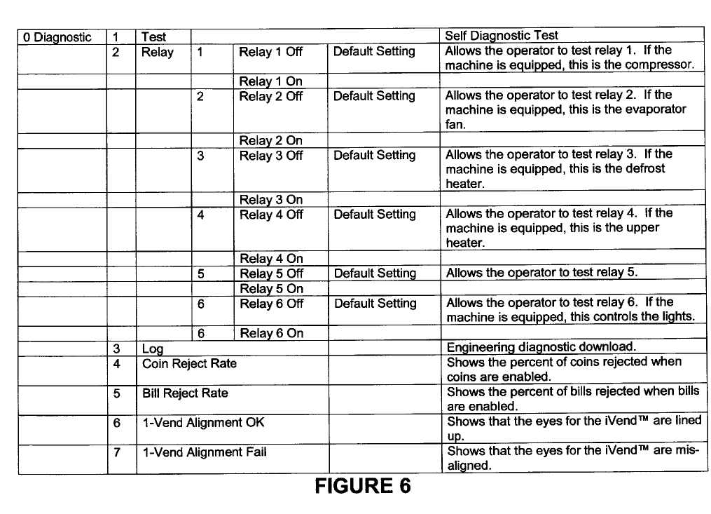

At a time selectable by the operator, here referred to as the end of the polling period (step 130), a diagnostic test instruction (see FIG. 6) can be entered into VMC keyboard 41 which causes VMC 40 to calculate what will be called a Coin Reject or Rejection Rate (step 132) which can be displayed (step 122) on VMC display 43 (see FIG. 6—the operator would push key 4 on VMC keypad 41). Another test instruction (key 5 on VMC keypad 41) would calculate what is called Bill Reject or Rejection Rate (step 142 of FIG. 3 which can be displayed (step 143)). A Coin Accept or Acceptance Rate and Bill Accept or Acceptance Rate can also be calculated and could, if desired, by displayed.

The calculations can be performed according to the following equations:

### Coin Reject Ratio or Rate Equation

The reject rate is determined only when one or more coins and/or tokens are enabled by VMC 40 and by the following equation, with the terms defined by “status descriptions” from the relevant table above:

Coin reject ratio=(rejected coins*100)/(rejected coins+accepted coins)

where

Rejected coins=(“coin type enabled but coins rejected”)+(“no credit message coins”)+(“slugs (with coins or tokens enabled”)), and

Accepted coins=(“coin type enabled sent to tubes”)+(“coin type enabled and sent to cash box”).

### Bill Reject Ratio or Rate Equation

The reject rate is determined only when one or more bills and/or coupons are enabled by VMC 40, and by the following equation with terms defined from the relevant table above:

Bill reject ratio=(rejected bills*100)/(rejected bills+accepted bills)

where

Rejected bills=(“bill type returns”)+(“bill type disabled bills rejected”)+(“bills rejected”), and

Accepted bills (“stacked bills”).

It is to be understood that in these equations, selected activity status information is used, but not all activity status information that is generated or available with MDB/ICP protocol. The VMC 40 must be programmed to use only the selected information (such as shown in the tables). However, this information is available for use in the calculations from the polling of coin acceptor 20 and bill validator 30 and can be selectively extracted. If any of the status bytes of interest have been generated by either the coin acceptor 20 or bill validator 30 at each polling command, they are accumulated and stored. At the end of the polling period (step 130), when the rejection and acceptance rates are calculated (steps 132 and 142), the relevant information for that period of vending machine operation (the time between steps 110 and 130), is available to VMC 40. The equations can be adjustable, even by the owner/operator.

Note how the information polled from coin acceptor 20 and bill validator 30 is an aggregation of several different reasons why a coin is not ultimately accepted (i.e. validated and credited). In this example, “rejected coins” is actually an aggregation or summation of three different conditions a coin could experience: (1) “coin type enabled but coins rejected” (e.g. could be a coin routing issue), (2) “no credit message coins” or coins for which no credit is given (e.g. not in a place in the coin acceptor where credit is given—it could be a slug or it could have fallen out of the coin routing path or out of the coin acceptor), and (3) “slugs (with coins or tokens enabled)” (e.g. counterfeit objects). It does not just monitor coins having the status description of “coin of enabled type has been rejected” (see table above). It collects information about a variety of reasons why a coin may not have been accepted or credited.

Similarly, “rejected bills” is an aggregation or cumulative count of not only bills of enabled type that have been rejected by the bill validator (e.g. do not meet validation standards), but also what are called “bill type returns” (e.g. could be a routing issue) and “bill type disabled bill rejected” statistics (see table above). Note that accepted and rejected information can be for bills sent to a bill validator recycler unit alone or in combination with a bill stacker. The recycler allows change to be made to customers with bills as well as coins. Such information about a bill recycler can be available in MDB protocol per, for example, MDB/ICP version 3.1.

Of course, what is included in the meaning of “rejected coins” and “rejected bills” in the equations can vary according to design. This can be selected and programmed.

The length of the polling period can be programmed by the operator. The time can be as short as in almost real time. For example, the rejection and acceptance rates could be calculated each polling command (which can be every fraction of a second). On the other hand, it could be set for a monthly calculation of rejection and acceptance rates, or even longer. It also could be variable. As mentioned, calculation and display of rejection and acceptance rates could be whenever the owner/operator checks on the vending machine. It could be set for other times or based on other factors, such as events.

As indicated in FIG. 3, both coin and bill rejection and acceptance rates can be calculated and displayed. Alternatively only one or the other could be calculated and/or displayed. Formulas for acceptance rates are:

### Coin Acceptance Ratio or Rate Equation

The acceptance rate or ratio is determined only when one or more coins and/or tokens are enabled by VMC 40.

Coin Accepted Ratio=(accepted coins*100)/(rejected coins+accepted coins)

where

Rejected coins=(“coin type enabled but coin rejected”)+(“no credit message coins”)+(“slugs (with coins or tokens enabled)”), and

Accepted coins=(“coin type enabled sent to tubes”)+(“coin types enabled and sent to cash box”).

### Bill Acceptance Ratio or Rate Equation

The acceptance rate is determined only when one or more bills and/or coupons are enabled by VMC 40.

Bill Acceptance Ratio=(accepted bills*100)/(rejected bills+accepted bills)

where

Rejected bills=(“bill type returns”)+(“bill type disabled bill rejected”)+(“bill rejected”), and

Accepted bills=(“stacked bills”).

Rejection and/or acceptance ratios can be stored in VMC memory or other memory. They could be accessed by appropriate means and methods and transferred to another device. As can be appreciated, the formulas/equations can vary. For example, in the equations set forth above, the ratios could be determined first and the ratio then multiplied by 100 to display a percentage. Alternatively, just the raw number could be shown (e.g. 0.06 (6%)) or just the raw coin count (e.g. 6/100).

The method of FIG. 3 allows the operator to analyze the number of coins or tokens that have been accepted and rejected by coin acceptor 20 and bills or coupons accepted or rejected by bill validator 30 over a period of time (or some other factor or criteria). Alternatively, or in addition, the rejection and acceptance information can be listed in data output as percentage of coins or token and/or bills or coupons by type.

The information can be used in a number of ways. It can simply be observed by the owner/operator or maintenance personnel. In one optional configuration, the VMC 40 can be programmed to display a message on VMC display 43, or light up an indicator or alarm LED 45, when the rejection percentage value exceeds a pre-programmed level.

For example, a high coin or bill rejection rate can indicate a malfunctioning component 20 or 30. Still further, if checked periodically, an increasing rejection rate can indicate a need for maintenance or a developing malfunction. By empirical testing or other means, the operator could program what would be considered an unacceptable rejection rate. If either 20 or 30 reach that rate, the VMC could be programmed to either disallow vending or could indicate on display 43 or with LED indicators 45 a malfunction or error condition to bring it to the attention of the operator.

Thus, as can be appreciated, by repeatedly polling devices 20 and 30, and extracting activity status data regarding each item attempted to be inserted into either, VMC 40 can develop, with substantial accuracy, a rejection rate for each component 20 and/or 30. An example would be to review the rejection rate periodically (e.g. daily coincident when an operator would routinely come to restock or collect coins and bills). The operator could note the rejection rate and allow it to continue to accumulate so that it provides a running average over time. Or, the operator could reset it to start over the counting of rejections. As can be appreciated, other regimes could be programmed or selected by the operator.

D. Options and Alternatives

As indicated above, the foregoing exemplary embodiment is by way of example and not limitation. Variations obvious to those skilled in the art are included within the invention.

The invention can be applied to machines utilizing coin or bill acceptors other than vending machines. Specific protocols involved can be other than MDB or DEX. A wide variety of coin or bill acceptors and validators can be utilized.

Further examples of options or variations are set forth in U.S. Pat. No. 7,076,329, incorporated by reference herein. U.S. Pat. No. 7,076,329 also discloses the ability to communicate to a remote device information from a VMC. One example is through wireless transmission. As can be appreciated, rejection rates for coins and/or bills could be communicated to a remote site, such as an owner/operator office. The owner/operator could, from that remote location, monitor rejection rates for any such vending machine 10. An owner/operator could use such remote communication capability to periodically check on the rejection and acceptance rates of each owned or operated machine. This would allow the owner/operator to gather such information remotely and to monitor it remotely. The owner/operator could send out maintenance or service personnel if an unacceptable rejection rate is indicated. Also, there are vending machines that allow an owner/operator to enter a code on the keypad on the front of the vending machine (the same keypad a customer would use to make a vending selection), and get diagnostic information on the external customer display of the vending machine. This would avoid having to open the machine and go into diagnostic mode to get a rejection rate. The owner/operator could quickly get the rate in this manner. Alternatively, the accepted and rejected data could be displayed in other than diagnostic mode (e.g. in “sales” mode).

Additionally, a method of monitoring a plurality of currency detectors or payment readers could similarly be set up by the manufacturer of the detector or reader. The manufacturer could remotely monitor performance to try to identify areas for improvement. For example, such aggregated data for many machines may indicate higher frequency of problems with one coin or bill denomination over another. The manufacturer could use this intelligence to improve performance regarding that denomination. It might also be used by a manufacturer or owner/operator to help adjust operation of a currency validator or detector. An example would be to increase or decrease the sensitivity of a magnetism sensor in a coin acceptor 20. Another would be to adjust some aspect of an optical detector in a bill validator 30. By using the two-way communication capabilities with the VMC, for example, the VMC might be programmed to send currency detector or card reader rejection rates to a remote location. The remote location could evaluate the information and/or communicate back with adjustment or tuning instructions for the currency detector or card reader. It could evaluate if performance is improved or not, and leave the adjustment in place or make further adjustments.

A still further alternative could be to utilize rejection ratios to assist coin acceptor and bill validator manufacturers in the design of better devices. By accumulating rejection rates for a variety of machines and environmental conditions, the data could be valuable to the designer and manufacturer of such currency detectors to help decrease rejections.

Still further, such data could help and be useful for fine tuning operation of currency detectors. Many present currency detectors have the ability to be what is called “tuned”. This is described in the published literature and operating manuals of the MEI CP7000 coin acceptor and the Coinco BillPro bill validator the Coinco. See, for example: Coinco Publication No. 925495 Rev. 1, entitled “BillPro™ Bill Acceptor Operation and Service Manual”, Date March 2004 (available from Coin Acceptors, Inc. 300 Hunter Avenue, St. Louis, Mo. 63124-2013 USA); Coinco Publication No. 925412, entitled “BillPro™ Series Bill Acceptor Installation & Operation (BP2 & BP4) Guide, Multi-Drop Bus Unit”, Date November 2002 (available from Coin Acceptors, Inc. 300 Hunter Avenue, St. Louis, Mo. 63124-2013 USA); Coinco Publication No. 927977 Rev. 2, entitled “Guardian 6000™ Operation and Service Manual”, Date January 20074 (available from Coin Acceptors, Inc. 300 Hunter Avenue, St. Louis, Mo. 63124-2013 USA); all incorporated by reference herein.

As is well known in the art, such tuning essentially trains the bill or coin validator 20 or 30 to correctly recognize a coin, token, bill, or coupon that is enabled and acceptable. Thus, by monitoring rejection rates according to the method of the exemplary embodiment, the operator and/or manufacturer has additional information that could be used tune or train recognition of enabled items. This can also help significantly in combating attempted cheating of the machines.

Data from the polling of activity status and/or any calculations of rejection or acceptance rates could be collected and stored digitally in any number of formats. For example, tables such as FIGS. 4 and 5 could be stored for any time period for any machine. Such tables could be used for some of the purposes described above. Alternatively, data could be accumulated over the operating life of the vending machine for historical record keeping.

Such data could be mined by interested parties for targeted purposes. For example, long-term rejection and acceptance rate information could be beneficial regarding understanding subtle factors of operation of coin or bill acceptors 20 and 30 or vending machine 10. The digital storage, analysis, and manipulation of such data is easily accomplished through use of databases and spreadsheets and associated software programming on personal computers.

As can be appreciated, the information can be useful for not only evaluating and analyzing operation of the vending machine and its components, but also detecting trends or indications. An example would be detection, over time, of an increasing reject rate. This information could be used, for example, to evaluate whether the coin or bill validator is moving towards malfunction.

Still further, it may be valuable to monitor rejection rates for each type of currency. For example, certain coins may have a higher reject rate than others. By appropriate programming, an option would be to keep track of reject rates based on coin or bill denomination rather than on total reject rate for all denominations. MBD/ICP protocol allows polling by type of coin or bill.

Another example would be to keep track of unusual activity. In other words, the system could be programmed to check if certain denomination bills (e.g., $20 bills) are attempted to be used more frequently late at night. This could allow pre-stocking the bill validator with appropriate change. This could be used to try to also see if attempts to cheat by using bogus $20 bills occur at any particular time frame (e.g. after midnight). This intelligence could be used to increase security during those times and/or to disable $20 bills during those time periods.

A still further option would be to combine the coin reject rate and bill reject rate into a consolidated reject rate. The operator could see with one number or percentage the rejection rate of both coin acceptor 20 and bill validator 30.

A still further option would be to conduct a real time test of bill or coin acceptor 20 or 30. By operating a diagnostic through key 4 or 5 of keyboard 41 on VMC 40, the operator could, in real time, insert various coins and/or bills and watch the immediate rejection rate. This could help the operator tune or adjust devices 20 or 30 (or replace) at that time or simply provide assurance that an acceptable acceptance rate is occurring, at least at that time. The software could be programmed to display what denomination of coin or bill is inserted and rejection or acceptance in real time (or some percentage or other calculation that might include prior coins or bills or other data).

Moreover, as indicated earlier, evaluation of performance of other payment acceptance machines (other than coin and bill devices) can also be accomplished using analogous methods. The MCP/ICP Protocol Version 3.0, Section 7, describes how a polling command can be made from the VMC of a vending machine to a credit card reader. The credit card reader would respond with information which can be selected to indicate total rejected attempted transactions. This can be applied in a similar fashion to proximity cards and proximity card readers. Published U.S. Patent Application US2005/0033688A1, incorporated by reference herein, describes such technology. As can be appreciated, the reasons for non-acceptance of a credit or debit card can be similar to or can vary from reasons associated with acceptance or rejection of coins or bills. For example, a credit card can be turned down by the card company for financial, identification (or lack thereof), or other reasons unrelated to physical parameters of the card. The card reader includes not only credit cards but debit cards, memory cards, key readers, or other forms or embodiments.

As can be appreciated by those skilled in the art, a number of other variations are possible. The general methods can be applied to a number of coin acceptors and bill validators, credit/debit card readers, a number of vending machines or other machines, and a number of interfaces between them. Such obvious variations will be included within the invention.

As can be appreciated, the various aspects of the invention allow a person to obtain a more accurate indication of currency detector or card reader performance than relying on a manufacturer's claim. It can also allow the owner/operator to be given an indication or even an alarm if there is a malfunction of such devices or an unacceptable rejection rate.

What is claimed is:

1. A method of analyzing operation of a currency detector or card reader, comprising:
a) deriving number of accepted and rejected transactions relative to the currency detector or card reader;
b) calculating a ratio of rejected to accepted transactions; and
c) storing the ratio.

2. The method of claim 1 wherein the currency detector or card reader comprises one of a coin accumulator, bill validator, credit card reader, or proximity card reader.

3. The method of claim 2 wherein the coin validator includes one or more of the following states: item inserted, item validated but not credited, item validated and credited.

4. The method of claim 2 further comprising different denominations of coins.

5. The method of claim 2 wherein bill validator comprises one or more of the following states: item inserted, item validated but not credited, item validated and credited.

6. The method of claim 2 wherein the currency comprises one or more of coins, tokens, paper currency, coupons.

7. The method of claim 2 wherein claims which are not acceptable currency comprise slugs, counterfeit bills, counterfeit tokens, counterfeit coupons.

8. The method of claim 1 wherein the calculation occurs for a period of time.

9. The method of claim 8 wherein the period of time is variable.

10. The method of claim 1 wherein the ratio is displayed, communicated to another device, or is used to produce a signal or alarm.

11. An apparatus for detecting rejection information from bill validators, coin acceptors, or card readers comprising:
a) a currency detector or card reader comprising an input, a processor, a validation sensor, and a storage location;
b) a controller for controlling a function;
c) a communication conduit between the currency detector or card reader and the controller;
d) a controller including software which issues an instruction to the currency detector or card reader at selected times to collect data or information from the currency detector or card reader from which rejection rates can be derived.

12. The apparatus of claim 11 wherein the currency detector or card reader comprises a coin acceptor.

13. The apparatus of claim 12 wherein the coin acceptor is programmable to accept one or more enabled coin or token denominations.

14. The apparatus of claim 12 further comprising one or more of the following states: item inserted but not validated, item validated but not credited, item validated and credited.

15. The apparatus of claim 11 further comprising a display for display of a rejection rate.

16. The apparatus of claim 11 further comprising a communications device adapted to transmit rejection information.

17. The apparatus of claim 16 wherein the communication device is adapted to transmit to a remote device.

18. The apparatus of claim 11 wherein the controller is a vending machine controller.

19. The apparatus of claim 18 in combination with a vending machine including at least one dispenser, a cabinet, and an input device such as a keyboard.

20. The apparatus of claim 11 wherein the controller is associated with a device that performs the function after validation and crediting of coins, or bills, credit cards, or proximity cards.

21. A method of evaluating performance of a currency detector or card reader comprising:
a) generating a signal indicative of an item recognized but not validated by the currency detector or card reader;
b) generating a signal indicative the item has been validated but not credited by the currency detector or card reader;
c) generating a signal indicative that the item has been validated and credited by the currency detector or card reader;
d) polling the currency detector or card reader periodically for status regarding each item;
e) accumulating information during each polling period;
f) deriving a ratio of accepted versus rejected items by comparing status of each item for the period.

22. The method of claim 21 wherein the currency detector or card reader is a coin acceptor.

23. The method of claim 21 wherein the currency detector or card reader is a bill validator.

24. The method of claim 21 wherein the currency detector or card reader is a credit card reader.

25. The method of claim 21 wherein the currency detector or card reader is a proximity card reader.

26. The method of claim 21 further comprising a second currency detector or card reader.

27. The method of claim 21 wherein the rejection and acceptance rates are utilized to prove operation of the currency detector or card reader.

28. A method of evaluating performance of a currency detector or card reader comprising:
a. defining events in the currency detector or card reader relative to a currency or card that comprise rejection events for the currency or card;
b. defining events in the currency detector or card reader relative to a currency or card that comprise acceptance events for the currency or card;
c. quantifying the number of rejection events for a selected factor;
d. quantifying the number of acceptance events for the selected factor;
e. storing the quantifications of rejection and acceptance events;
f. associating the quantifications with each other.

29. The method of claim 28 wherein the factor comprises a pre-set period of time.

30. The method of claim 28 wherein the step of defining events comprises considering one or more of;
a. routing of currency in a currency detector;
b. acknowledgement of presence of currency in a currency detector or presence of a card with a card reader;
c. enablement of a currency in a currency detector or a card with a card reader;
d. validation of a currency in a currency detector or a card with a card reader; or
e. crediting of a currency in a currency detector or a card with a card reader.

31. The method of claim 28 wherein the currency comprises
a. coins or tokens;
b. bills or coupons; or
c. both.

32. The method of claim 28 wherein the card comprises a credit or debit card.

33. The method of claim 28 further comprising using the associating for one or more of:
a. analyzing performance of the currency detector or card reader or the machine or users of the machine associated with the currency detector or card reader;
b. adjusting the currency detector or card reader;
c. training the currency detector or card reader;
d. monitoring for malfunction of the currency detector or card reader;
e. monitoring for indications of potential future malfunction of the currency detector or card reader;
f. analyzing the accuracy of the currency detector or card reader
g. monitoring the currency detector or card reader for currency detector or card reader usage patterns;
h. monitoring the currency detector or card reader for currency or card usage patterns;
i. monitoring the currency detector or card reader for cheating attempts;
j. designing the currency detector or card reader, or its operation.

34. The method of claim 28 further comprising generating a signal based on comparison of the quantifications with a reference.

35. The method of claim 24 wherein the signal actuates a display or a human-perceivable notification or alarm.
